(19) United States
(12) Patent Application Publication
(10) Pub. No.: US 2013/0301415 A1
(43) Pub. Date: Nov. 14, 2013

(54) METHODS AND SYSTEMS FOR MANAGING MEDIA TRAFFIC BASED ON NETWORK CONDITIONS

(71) Applicant: AVVASI INC., WATERLOO (CA)

(72) Inventors: Michael Archer, Cambridge (CA); Michael Gallant, Kitchener (CA)

(21) Appl. No.: 13/852,927

(22) Filed: Mar. 28, 2013

Related U.S. Application Data
(63) Continuation-in-part of application No. 13/631,366, filed on Sep. 28, 2012.
(60) Provisional application No. 61/647,132, filed on May 15, 2012.
(60) Provisional application No. 61/541,046, filed on Sep. 29, 2011.

(51) Int. Cl. H04W 28/08

(52) U.S. Cl. CPC H04W 28/08
USPC 370/235

(57) ABSTRACT

Methods and systems for providing a network monitoring system capable of correlating client device sessions, including media streaming sessions, and client device location information to dynamically identify changes in utilization load levels in portions of a network. Further action may be pursued to modify sessions in response to detection of utilization load level changes, based on one or more policies specified by a service provider.

### FIELD

The described embodiments relate to network monitoring and traffic management. In particular, the described embodiments relate to monitoring radio access network utilization load levels in a distributed network in order to manage media traffic within the network.

### BACKGROUND

The popularity of streaming multimedia content on mobile devices continues to increase. The advent of next generation mobile networking standards promises to cause increased bandwidth consumption by mobile device users.

Multimedia services that provide real-time streaming may contribute significantly to the amount of traffic on mobile and other data networks. Moreover, mobile data networks may be unable to support high bandwidth usage by a large number of devices during peak times or in overloaded areas, resulting in network congestion. Such network congestion may result in a degraded user experience and impaired data usage more generally, among other problems.

### SUMMARY

In a broad aspect, there is provided a system for managing traffic on a network, the network comprising a plurality of nodes facilitating a media session between a server and a client device, the system comprising: a network resource modeling module configured to receive an indication of the at least one status characteristic; determine a network utilization load level based on the at least one status characteristic; and at least one processor configured to perform a media session action based on the network utilization load level.

In some cases, the system may further comprise a network event collector configured to receive at least one status characteristic from at least one selected node of the plurality of nodes, wherein the network resource modeling module receives the indication of the at least one status characteristic from the network event collector.

The network event collector may be further configured to determine at least one additional status characteristic at one or more other nodes in the plurality of nodes.

The at least one status characteristic may be transmitted to the network event collector in response to a change in a utilization load level determined by the at least one selected node.

The at least one status characteristic may be transmitted to the network event collector in response to a request from the network event collector. The at least one selected node may be within a radio access network. The at least one selected node may monitor at least a portion of a radio access network. The at least one status characteristic may be the utilization load level determined by the at least one selected node.

The utilization load level may be determined based on radio transmit/receive power levels at the at least one selected node.

The network resource modeling module may be further configured to model a client device media session associated with a subscriber at the at least one selected node.

The media session action may be based on the network utilization load level.

The media session action may be selected from the group consisting of: transcoding the media session, video buffer shaping the media session; policing the media session; marking the media session; and blocking the media session.

The at least one status characteristic may be selected from the group consisting of a radio receive power level, a radio transmit power level, a signal-to-noise ratio and a bit rate.

The at least one status characteristic may correspond to a plurality of client devices.

The client device media session may be modeled based on a location and an identity of the client device on the network.

The at least one status characteristic may be transmitted to the network event collector in response to a change in the location of the client device.

In another broad aspect, there is provided a method for managing traffic on a network as described herein, the network comprising a plurality of nodes facilitating a media session between a server and a client device, the method comprising: receiving, at a network resource modeling module, an indication of the at least one status characteristic; determining a network utilization load level based on the at least one status characteristic; and performing a media session action based on the network utilization load level.

In another broad aspect, there is provided a non-transitory computer-readable medium storing computer-executable instructions, the instructions for performing a method for managing traffic on a network as described herein, the network comprising a plurality of nodes facilitating a media session between a server and a client device, the method comprising: receiving, at a network resource modeling module, an indication of the at least one status characteristic; determining a network utilization load level based on the at least one status characteristic; and performing a media session action based on the network utilization load level.

### BRIEF DESCRIPTION OF THE DRAWINGS

Preferred embodiments will now be described in detail with reference to the drawings, in which:

FIG. 1 is a simplified block diagram of an example mobile data network;

FIG. 2 is a block diagram of a network segment with an example media service gateway;

FIG. 3 is a simplified schematic diagram of an example media traffic management system;

FIG. 4 is a simplified block diagram of an example media service gateway;

FIG. 5 is a simplified schematic block diagram of an example traffic management system;

FIG. 6A illustrates one example state of an example network resource model;

FIG. 6B illustrates a simplified example network resource model;

FIG. 7A is a process flow diagram for an example method of session tracking;

FIG. 7B is a process flow diagram for another example method of session tracking;

FIG. 8A is a process flow diagram for an example network resource model update process;

FIG. 8B is a process flow diagram for another example network resource model update process; and

FIG. 9 is a process flow diagram for an example monitoring process.

The drawings are provided for the purposes of illustrating various aspects and features of the example embodiments described herein. Where considered appropriate, reference numerals may be repeated among the figures to indicate corresponding or analogous elements.

### DETAILED DESCRIPTION

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, mobile telephone, smartphone or any other computing device capable of being configured to carry out the methods described herein.

Each program may be implemented in a high level procedural or object oriented programming or scripting language, or both, to communicate with a computer system. However, alternatively the programs may be implemented in assembly or machine language, if desired. The language may be a compiled or interpreted language. Each such computer program may be stored on a non-transitory computer readable storage medium (e.g. read-only memory, magnetic disk, optical disc). The storage medium so configured causes a computer to operate in a specific and predefined manner to perform the functions described herein.

While particular combinations of various functions and features are expressly described herein, other combinations of these features and functions are possible that are not limited by the particular examples disclosed herein, and these are expressly incorporated within the scope of the present invention.

As the term module is used in the description of the various embodiments, a module includes a functional block that is implemented in hardware or software, or both, that performs one or more functions such as the processing of an input signal to produce an output signal. As used herein, a module may contain sub-modules that themselves are modules.

Radio access network (RAN) utilization load is an important aspect in the delivery of video services in packet based networks, particularly wireless packet based networks, due to constrained air interface resources and the variable nature of the throughput. Achieving a consistent customer experience in these environments can be challenging.

What constitutes a particular service, and how the service is delivered to users, poses a considerable challenge in modeling. Moreover, the delivery of packet based services in the context of a wireless network is significantly complicated by the non-deterministic nature of wireless transmission (e.g., due to variable RF characteristics).

Current state of the art wireless networks are usually designed to be hierarchical in nature, with each tier in the hierarchy managing a distinct and well-defined domain (e.g., air interface, RAN, packet core, etc.). This simplifies management and reduces the amount of information that is required to be shared across domains. For example, the packet core can treat access networks independently, and model services as streams of packets being delivered by a packet network via some bearer with defined, generic, networking properties. Generally, current management techniques attempt to make each RAN appear as an ‘ordinary’ packet network, although this can be difficult when the RAN exhibits behavior that is atypical of a fixed packet network. For example, the throughput of the RAN can vary rapidly based on the position and mobility (e.g., velocity) of mobile devices within the RAN, as well as the amount of data each mobile device is transmitting at any given moment, and what the generated interference profile may look like for any particular combination of variables.

In short, RAN throughput can change dynamically according to a wide range of variables. This makes the delivery of services, such as video, extremely challenging with anything other than “best effort” modeling, which is how such services are currently delivered.

Attempts have been made to simplify RAN models based on relative prioritization. This involves deploying a Quality-of-Service (QoS) model as far out into the RAN as feasible, and allowing certain packets to be prioritized over others. However, relative prioritization suffers from the problem that one high priority traffic type can starve lower priority traffic types of network resources.

To mitigate this problem, attempts also have been made to define the resources assigned to each class of the prioritization. However, these solutions tend to lead to very complex QoS configurations in the networks, which require the multiple traffic handling nodes to be precisely coordinated with exactly the same traffic handling schemes. This may not be possible in a heterogeneous network environment. Accordingly, in at least one aspect, the described embodiments provide modeling methods that can be used to abstract the complexities of service delivery through RANs, thus providing a more cost effective solution that does not require expensive hardware queues throughout the delivery chain. The simpler model avoids the complexities of complex QoS configuration and queues, by instead reacting to variations in RAN throughput and the current load demand (e.g., from mobile devices). Moreover, these models enable more efficient utilization of network resources compared to more static, QoS-style configurations.

Mobile data networks are commonly monitored to identify performance issues. Performance problems may be temporary, in the case of an equipment failure, or they may be chronic, in the case of an over-subscribed network node. Some performance problems may also be transient, such as where the demand for a particular network resource exceeds its capacity (i.e., congestion). While the solution for chronic performance problems may be to install additional capacity, such additional capacity may not be required to address transient issues. For example, a node may experience congestion only during a short period of time each day, or on certain days of the week (e.g., at a sports stadium). In such situations, it would be preferable to operate the network in such a way that the available capacity is sufficient to satisfy demand.

Conventional approaches to address network performance issues include throttling some or all network sessions to a predetermined level, such that network throughput is reduced within available capacity. While effective, such an approach can result in denial of some services (e.g., video streaming), which may require more bandwidth than is available on a throttled link.

Moreover, the mere identification of performance problems may be complicated in the case of mobile data networks, particularly where a client device may be in simultaneous communication with multiple nodes. For example, in a Universal Mobile Telecommunications System (UMTS) network, transmissions from a client device may be received at a plurality of base stations and reassembled at a support node. Each individual base station may lack sufficient knowledge about the various data sessions that would allow it determine the actual utilization load level at the node. Rather, the base station typically can only estimate network load based on radio transmit/receive power levels. As a result, it may be difficult to pinpoint a specific base station node at which congestion is occurring.

A further difficulty is encountered in the coarseness of conventional monitoring. Typically, network probes in a RAN provide only aggregate data at widely spaced intervals (e.g., every 15 minutes, every hour, etc.). Such coarse data may be insufficient to allow congestion alleviation measures to be implemented in real-time. Rather, only manual configuration can be performed on the basis of this coarse data, which may require designing for “worst-case” scenarios. More fine-grained reporting, for example every minute, may be needed to support real-time monitoring and response.

However, simply increasing the granularity of reporting from network probes may require significant resources to be expended transmitting and processing the reporting data, which may be impractical and unscalable. For example, tracking every user session in a network sector may require monitoring millions of messages per second in some scenarios. These resources may be effectively wasted during periods in which there is no network congestion at the monitored nodes.

The described embodiments provide a scalable approach for real-time monitoring and response to changes in network utilization at selected nodes. In one aspect of the approach, predetermined thresholds of interest are used to monitor only those nodes that exhibit increasing levels of utilization, are on the verge of experiencing high levels of utilization, or which are at risk of experiencing high levels of utilization. In this way, network nodes that are well within capacity need not be monitored, conserving resources. Moreover, responses preferably can be made to increases in network utilization before congestion (e.g., node or link saturation) actually occurs, which would result in dropped packets and degraded experiences.

More particularly, the described methods and systems provide a network monitoring system capable of correlating client device media sessions, including media streaming sessions, and client device location information to dynamically identify changes in utilization load levels in portions of a network. In some embodiments, further action may be pursued in response to detection of utilization load level changes, possibly based on one or more policies specified by a service provider.

Most packet based services generally do not require a minimum level of bandwidth resource assigned. However, certain types of real time or streaming services usually require some minimum bandwidth in order to function reliably. For example, streaming video typically consumes large amounts of bandwidth on today's networks as up to 80% of the bandwidth on wireless networks can be occupied in delivering video. Video is currently delivered with a wide array of formats, resolutions and bandwidths that may or may not be appropriate for the target devices.

In at least one aspect, the described embodiments provide methods and systems for manipulating media flows (e.g., video streams) in conjunction with network modeling, such that the service can be delivered using fewer network resources than requested. More particularly, the manipulation can be achieved in a way that is largely transparent to the user, where the user experience is not substantially different from that requested by the user.

Put another way, the described methods and systems can manipulate data traffic, and video traffic in particular, based on predefined policies and actions, so as to match the transient throughput conditions of RAN networks, thereby improving the consistency of the delivered services, including video. Moreover, by delivering real-time awareness of the network conditions and providing the ability to manipulate traffic, the described systems and methods enable service provider to maximize opportunities for delivering paid and subsidized content.

Actions and policies may depend on a number of factors. For example, the location within a network of the utilization load level changes, whether at cells, backhaul nodes or within the core network, may impact the action to be taken.

Similarly, the type or source of the data being transmitted may impact the action to be taken. For example, access to certain over-the-top services such as YouTube™ may be prioritized, or streaming multimedia data may be transcoded during periods of high utilization load levels or congestion.

In some cases, delivery of data to certain devices may be prioritized or de-prioritized according to a subscription associated with those devices. For example, a device may be associated with a subscription tier that provides a minimum quality or Quality of Experience (QoE) target for streaming video.

To facilitate network monitoring, probes may be provided at various network nodes, including in the RAN and core network. Probes may differ, and be adapted, according to the type of node to be monitored. For example, a cell probe may differ from a core network probe, both in configuration and in the type of data reported.

Probes may be software modules comprised within other network devices, such as a Radio Network Controller (RNC) in the case of a cell probe. In other cases, probes may be hardware devices interfaced with network devices using a suitable communication interface such as, for example, Ethernet.

Generally, a probe may monitor status characteristics at one or more network nodes. Status characteristics may comprise information relating to the utilization load level changes at a monitored node. Examples of status characteristics are set out further below, but may comprise radio transmit/receive power levels, load and session data, including CPU or network utilization load levels, number of devices connected, session information, session mobility updates, and the like.

In some cases, a probe may be configured to identify a plurality of utilization load level ranges, and threshold levels between the utilization load level ranges. For example, threshold levels may be based on a load percentage such that, when a predetermined load percentage is exceeded, a higher utilization load level range is identified. The probe may further be configured to perform an action, such as transmitting an indication to a monitoring device, when a utilization load level range changes.

In some embodiments, monitoring may be incorporated into the nodes directly, and made available using an application programming interface (API).

Using probes in the RAN and core network, or monitoring feeds from the network nodes themselves, allows for load detection across multiple levels of the overall network. A Network Resource Model (NRM) can be used to take into account the load and session data based on status characteristics reported from various probes or nodes. Moreover, by monitoring session data, device mobility may also be taken into account, as devices handover from cell to cell, or region to region.

In some embodiments, when a high utilization load level is detected, media sessions may be rate throttled or blocked, in accordance with a predetermined policy, until a high utilization condition is alleviated, for example.

In other embodiments, when a high utilization load level is detected, a more granular approach may be used and proactive efforts (e.g., transcoding to lower bit rates and resolutions, stream switching, etc.) may be made to reduce utilization load levels or pre-empt congestion in response to the increased network utilization.

Accordingly, in conjunction with network monitoring, a media service gateway (MSG) may modify streaming media data in response to increased utilization load levels detected by an NRM module. Such modification, such as transcoding, may be triggered by predetermined utilization load levels. Specific actions to be taken can be defined in one or more utilization policies.

A utilization policy, sometimes referred to as a congestion policy, may be applied directly to a media session between a server (e.g., video server located on the Internet) and a client device (e.g., client device connected to a monitored cell). A utilization policy may also be applied to all media session for a particular location. For example, media session data requested by the client device may be intercepted and routed to the MSG for transcoding.

The NRM module may monitor new and on-going media sessions for some or all devices. Thus, if a media session is started on a cell site, backhaul link, or core network with high utilization, or if a media session is impacted by a cell site or sites with high utilization, backhaul node or core node, a utilization policy may be applied to the media session. The utilization policy may specify that transcoding should be applied to the media streaming sessions. In some cases, the utilization policy may specify denying or re-directing the media streaming session.

Accordingly, delivery of media streams may be constrained by the media service gateway during periods of high or increasing utilization. When utilization decreases or stabilizes, the constraint may be alleviated or removed. For example, transcoding may be discontinued or a higher bit rate may be allowed.

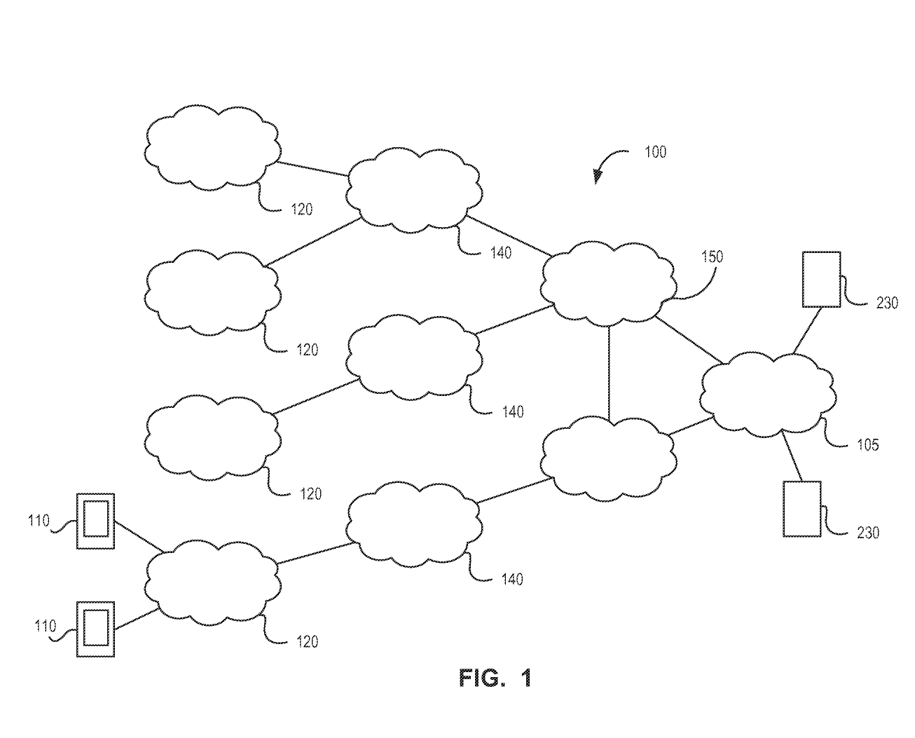

Referring now to FIG. 1, there is illustrated a simplified block diagram of an example mobile data network.

Data network 100 generally has one or more core networks 150, a plurality of backhaul network nodes 140, and a plurality of cell sites or locations 120. A plurality of locations may be referred to collectively as a radio access network (RAN).

Core network 150 may include one or more network routers (not shown) that provide data links between backhaul network nodes 140, using suitable networking protocols and equipment, the selection of which will be apparent to those skilled in the art. For example, in one example, backhaul network nodes 140 may be connected to a router within core network 150 via fiber optic cable using a 1 Gbps Ethernet or 10 Gbps Ethernet protocol.

Core network 150 may include, for example, General Packet Radio Service (GPRS) nodes, Evolved Packet Core (EPC) nodes, or other 3G and 4G nodes, and their equivalent and successor standards. In some cases, multiple physical nodes may be considered to be a single node for the purposes of the described embodiments.

Core network 150 may be further connected to other networks, which collectively constitute the Internet or portions thereof. Accordingly, core network 150 allows for data traffic to be transferred to and from the Internet to devices connected to RANs 120 via backhaul network nodes 140.

Backhaul network nodes 140 may similarly have one or more network routers providing data links from RANs 120, which may be located in disparate geographic locations, to the core network 150, which may be concentrated at relatively fewer locations.

The locations 120 may be, for example, Universal Mobile Telecommunications System (UMTS) nodes, 3GPP Long-Term Evolution Advanced (LTE Advanced) nodes, Worldwide Interoperability for Microwave Access (WiMAX) nodes, other 3G and 4G nodes, and their equivalent and successor standards. In some cases, multiple physical nodes may be considered to be a single node for the purposes of the described embodiments.

For example, a metropolitan area may have dozens or even hundreds of sites or locations 120 located across the area. Each location may be connected to a backhaul network node 140, concentrated in one or relatively few geographic locations, such as a data center. In some cases, the location may be connected via a wired connection. In other cases, the location may be connected via a wireless connection. The data center may also be a point of presence for the core network 150.

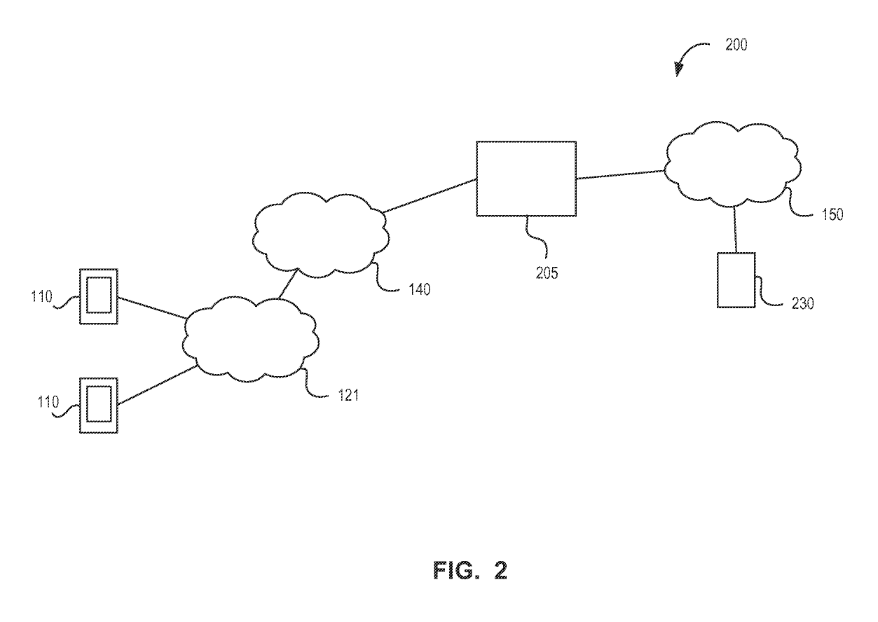

Referring now to FIG. 2, there is illustrated a block diagram of a network segment with a media service gateway in accordance with some example embodiments described herein. Network segment 200 may be a portion of network 100 of FIG. 1.

As shown, network segment 200 has one RAN 121, which is connected to a backhaul network 140. RAN 121 may include one or more locations, such as locations 120 of FIG. 1. Backhaul network 140 connects to the core network 150. Media service gateway 205 is generally within the core network 150, which connects RAN 121 and backhaul network 140 to other networks, e.g. the Internet. Accordingly, data traffic from client devices 110, which connect to RAN 121, backhaul network 140, and core network 150, traverses media service gateway 205.

Media service gateway 205 is generally configured to forward data packets associated with the data sessions of each client device to and from core network 150 with minimal latency. In some cases, as described herein further, media service gateway 205 may modify the data sessions, particularly in the case of media sessions (e.g., streaming video or audio).

Client devices 110 generally communicate with one or more servers 230 accessible via core network 150. It will be appreciated that servers 230 may not be directly connected to core network 150, but may be connected via intermediate networks 105, which may include the Internet. In some cases, servers 230 may be edge nodes of a content delivery network (CDN).

In some embodiments, media service gateway 205 may be provided elsewhere within the core network 150, in which case data traffic may be tunneled through core network 150 to and from the media service gateway.

In some other embodiments, the media service gateway 205 may be placed closer to the backhaul network 140 or the RAN 121.

It will be appreciated that network segment 200 shows only a subset of a larger network, and that data networks will generally have a plurality of network segments, such as network segment 200.

Although the exemplary embodiments are shown primarily in the context of mobile data networks, it will be appreciated that the described systems and methods are also applicable to other network configurations. For example, the described systems and methods could be applied to data networks using satellite, digital subscriber line (DSL) or data over cable service interface specification (DOCSIS) technology in lieu of, or in addition to a mobile data network.

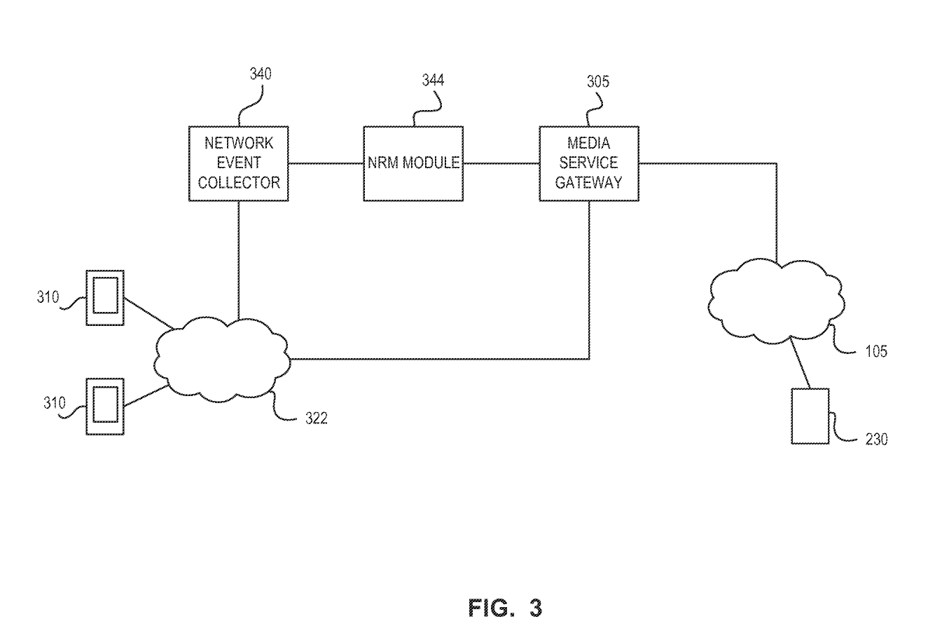

Referring now to FIG. 3, there is shown a simplified schematic diagram of a media traffic management system.

System 300 generally includes a RAN network 322, which may comprise one or more cell sites or locations. One or more client devices 310 connect to the RAN network to establish a data session. User plane data traffic from each client device 310 is communicated to and from a network 105—and other devices connected to network 105—via a media service gateway 305, allowing the media service gateway to monitor or modify the data sessions. For example, media service gateway 305 may monitor and modify a media session between client device 310 and media server 230.

A network event collector (NEC) 340 receives status characteristics from network probes and node feeds, which may be provided for devices within RAN 322. For example, radio network controllers and base transceiver stations in RAN 322 may provide status characteristics regarding, for example, radio transmit/receive power levels, utilization, and device mobility. Status characteristics may further include data about each client device using a RAN, including location and mobility, device type (e.g., International Mobile Equipment Identity [IMEI]) and subscriber information (e.g., International Mobile Subscriber Identity [IMSI] or Mobile Subscriber Integrated Services Digital Network Number [MSISDN]). Status characteristics may also include aggregate information about the RAN, including, radio transmit/receive power levels and the number of subscribers using a particular node, which can be coarse indicators of utilization load levels.

This data may be provided to the NEC 340 via any number of protocols, e.g., proprietary binary, or standard SOAP or Diameter protocols. NEC 340 then aggregates and adapts this data before providing its own information to a network resource model (NRM) module 344.

In some alternative embodiments, full control plane data and status characteristics may be provided “in band” (i.e., inserted into the user data session) and provided to the NRM module 344 via the media service gateway 305.

In general, NRM module 344 may also obtain information about network conditions (e.g. throughput) and media sessions (e.g. bit rates) from analysis of user plane data. NRM module 344 may also obtain information about subscribers (e.g. IMSI) from analysis of control plane data. In some embodiments, one or more of NEC 340, NRM module 344 and media service gateway 305 may be provided in a single device. In such cases, the analysis of user and control plane data described above may be performed by the media service gateway 305. In other embodiments, the devices may be in communication via a network, for example. In such cases, the analysis of user and control plane data described above may be performed by a gateway or device other than the media service gateway 305 such as a Gateway GPRS Service Node (GGSN), PDN Gateway (P-GW), Policy and Charging Enforcement Function (PCEF), or Deep Packet Inspection (DPI) device.

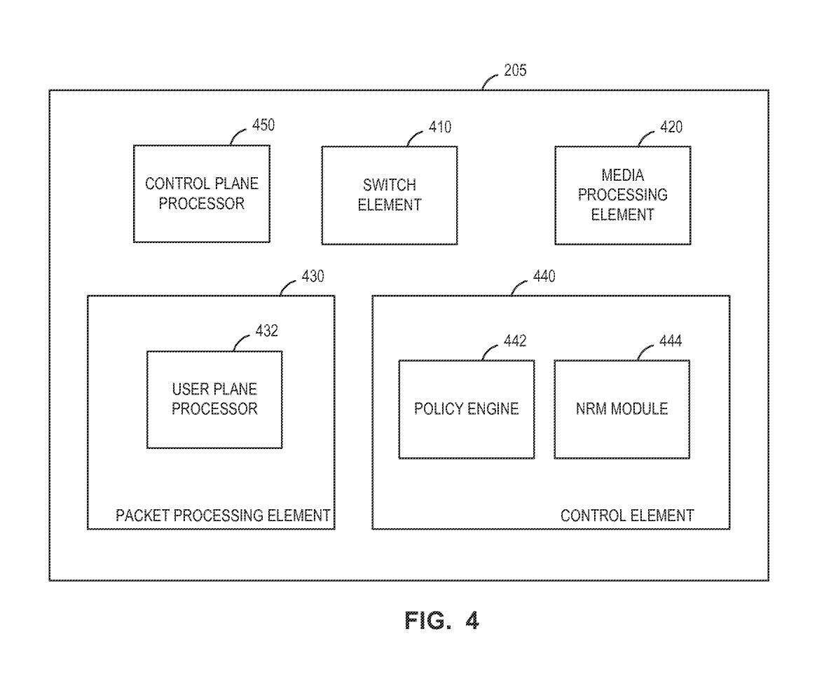

Reference is next made to FIG. 4, illustrating a simplified block diagram of a media service gateway 400, which is an example implementation of media service gateway 205 of FIG. 2.

Media service gateway 400 is generally configured to route generic network data traffic for client devices, such as client device 110, to and from a network, such as core network 150 and the Internet. However, media service gateway 400 is further configured to identify media sessions in generic network data traffic, and to permit selective media session-based policy execution and traffic management of in-progress communication sessions (“flows”). This is a significant enhancement over conventional per-flow or per-subscriber application of policies, in which policies are applied to individual flows (on a per packet or per flow basis) or applied to all data for a particular subscriber (per subscriber). Media service gateway 400 may be configured to determine and enforce media session-based policies to balance the overall quality of experience (QoE) and network utilization for all users, based on the service provider's policy rules. Determinations and enforcement can be performed by working in a closed-loop mode, using continuous real-time feedback to optimize and tune individual media sessions. In conjunction with detailed media session analysis and reporting, media service gateway 400 may provide control and transparency to service providers attempting to manage rapidly growing media traffic on their network.

To accomplish this, media service gateway 400 performs a number of functions that would conventionally be implemented via separate interconnected physical appliances. Implementation in an integrated architecture, which supports a wide range of processor options, is beneficial in order to reduce cost while improving performance and reliability. Accordingly, media service gateway 400 may have one or more switch elements 410, one or more media processing elements 420, one or more packet processing elements 430, one or more control elements 440, and one or more control plane processors 450, in an integrated platform. In some embodiments, the function of one or more of switch elements 410, media processing elements 420, packet processing elements 430, control elements 440, and control plane processors 450 may be integrated, such that a subset of the elements implements the entire functionality of media service gateway 400 as described herein. In some embodiments, one or more of the elements may be implemented as a server “blade”, which can be coupled together via a backplane. Each of the elements may comprise one or more processors and memories.

Switch elements 410 may be configured to perform control and user plane traffic load balancing across packet processing elements. Each switch element 410 may comprise one or more load balancers configured to distribute traffic from a large number of subscribers evenly across one or more packet processing elements 430. The traffic may be re-balanced between one or more packet processing elements 430 in the event of a packet processing blade 430 failure.

Switch elements 410 may be configured to operate the media service gateway 400 in one or more of a number of intersection modes. The intersection modes may permit passive monitoring of traffic, active management of traffic, or a combination thereof, for example by using an appropriate virtual local area network (VLAN) configuration.

Switch element 410 may be configured to allow packets that do not relate to media sessions to be forwarded without further processing, resulting in minimal added latency, while permitting packets that may relate to media sessions to be subjected to further processing.

Media processing element 420 may be configured to perform inline, real-time, audio and video transcoding of selected media sessions. Media processing element 420 may comprise one or more general purpose or specialized processors. Such specialized processors may be optimized for media processing, such as integrated media processors, digital signal processors, or graphics processing units.

Such processors operate on media processing element 420 and may implement individual elementary stream transcoding on a per-segment basis. A segment can be defined as a collection of sequential media samples, which starts at a selected or random access point. The processors may exchange control and configuration messages and compressed media samples with one or more packet processing elements 430.

Media processing element 420 may generally perform bit rate reduction. In some cases, media processing element 420 may perform sampling rate reduction (e.g., spatial resolution and/or frame rate reduction for video, reducing sample frequency and/or number of channels for audio). In some other cases, media processing element 420 may perform format conversion for improved compression efficiency, whereby the output media stream being encoded may be converted to a different, more efficient format than that of the input media stream being decoded (e.g., H.264/AVC vs. MPEG-4 part 2).

Control element 440 may generally perform system management and (centralized) application functions. System management functions may include configuration and command line interfacing, Simple Network Monitoring Protocol (SNMP) alarms and traps and middleware services to support software upgrades, file system management, and system management functions.

Control element 440 may generally comprise a processor and memory configured to perform centralized application functions. Centralization of processing at control element 440 may be advantageous as, due to load balancing, no single packet processing element 430 generally has a complete view of all sessions within a given network device, nor a view of all network devices.

Control element 440 may include a policy engine 442. The policies available at the media service gateway 400 may be dynamically changed by, for example, a network operator. In some cases, the policy engine 442 of the control element 440 may access policies located elsewhere on a network. For example, the policy engine 442 may gather media session policies based on the 3rd Generation Partnership Project (3GPP) Policy Control and Charging (PCC) architecture ecosystem (e.g., with a Policy and Charging Rules Function (PCRF)). In such embodiments, the policy system may enforce policy (i.e., carry out a Policy Control Enforcement Function (PCEF) with Application Function (AF), or Application Detection and Control (ADC)).

The policy engine 442 may maintain a set of locally configured node-level policies, and other configuration settings, that are evaluated by a rules engine in order to perform active management of subscribers, locations, and media sessions. Media sessions may be subject to global rules and affected by dynamic policies triggered during the lifetime of a session. Accordingly, the policy engine 442 may keep track of live media session metrics and network traffic measurements by communicating with the NRM module 444. The policy engine 442 may use this information to make policy decisions when each media session starts, throughout the lifetime of the media session, or both, as the policy engine 442 may adjust polices in the middle of a media session due to changes, e.g. in network conditions, changes in business objectives, time-of-day, etc.

The policy engine 442 may utilize device data relating to the identified client device, which can be used to determine device capabilities (e.g., screen resolution, codec support, etc.). The device database may comprise a database such as Wireless Universal Resource File (WURFL) or User Agent Profile (UAProf).

The policy engine 442 may also utilize subscriber information. In some cases, subscriber information may be based on subscriber database data obtained from one or more external subscriber databases. Subscriber database data may include quotas and policies specific to the user and/or a subscription tier. The subscriber database may be accessed via protocols such as Diameter, Lightweight Directory Access Protocol (LDAP), web services or other proprietary protocols. Subscriber database data may be enhanced with subscriber information available to the media service gateway 400, such as a usage pattern associated with the subscriber, types of multimedia contents requested by the subscriber in the past, the current multimedia content requested by the subscriber, time of the day the request is made and location of the subscriber making the current request, etc.

A by-product of location-based and media-session based policy is that location- and session-related measurements, such as bandwidth usage, quality of experience (QoE) measurements, transcoding efficiency measurements, and network utilization load levels can be continuously computed and made available in real-time to facilitate timely policy decisions. Media service gateway 400 may implement these functions through the NRM module 444.

The NRM module 444 may implement a hierarchical subscriber and network model and load detection system that receives location and bandwidth information from packet processing elements 430 and from external network nodes, such as radio access network (RAN) probes, to generate and update a real-time model of the state of a mobile data network, in particular domains, e.g. sectors, with high utilization. The network resource model may be based on data from at least one network domain, where the data may be collected by network event collector 340 using one or more network probes or node feeds. The NRM module 444 may implement a location-level utilization detection algorithm using control plane data and other measurement data, including device location, round-trip delay time (RTT), throughput, packet loss rates, window sizes, and the like from packet processing elements 430. The NRM module 444 may then provide the policy engine with the currently modeled cell load for one or more cells.

NRM module 444 may also receive per-session statistics such as session bandwidth utilization and quality metrics from packet processing elements 430 for ongoing session tuning and aggregate limit control. It may also receive updates from a control plane processor to enable mapping subscribers and associated traffic and media sessions to locations.

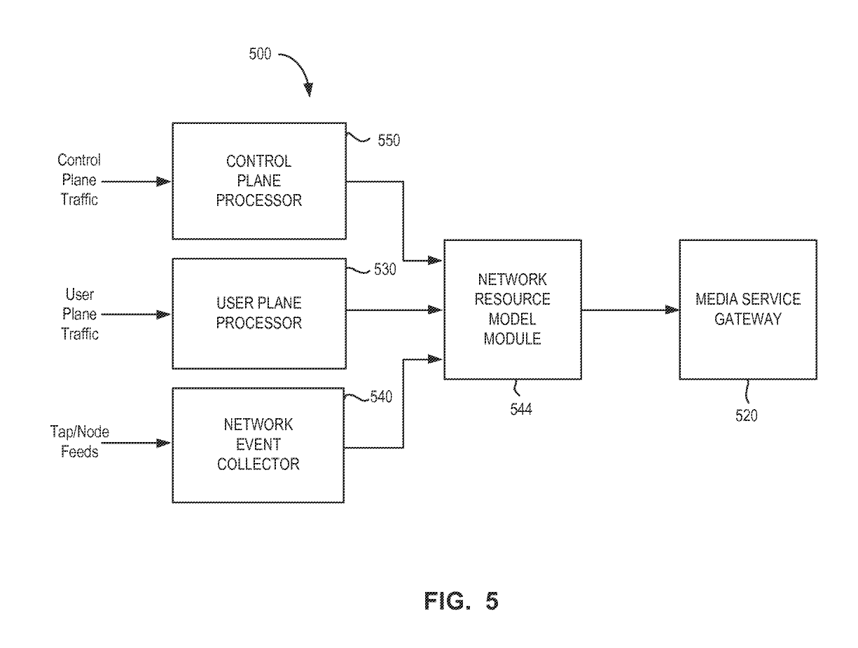

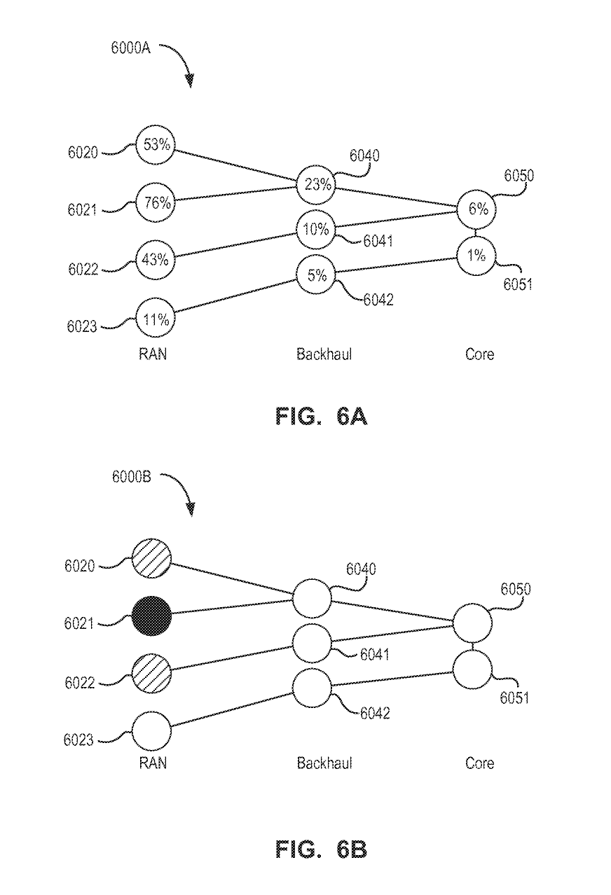

In some embodiments, media service gateway 400 may include the NRM module 444. In other embodiments, NRM module 444 may be a standalone device or server, which communicates with media service gateway 400 using a suitable network for example. The operation of NRM module 444 is described further with reference to FIGS. 5 and 6A-6C.

Packet processing element 430 may be generally configured to analyze user plane traffic across all layers of the TCP/IP (or UDP/IP, or other equivalent) networking stack and identify media sessions via user plane processor 432. To facilitate processing with minimal latency and maximum throughput, user plane processor 432 may split processing workloads into fast-path and slow-path modules, which provide separate threads of execution. This avoids using a single thread of execution to process every packet, which could result in excessive latency for packets that require significant processing and also fail to take advantage of parallelization.

The fast-path module may implement a first stage of packet processing, which requires only a minimal amount of computational effort. Packets that do not require advanced processing may be forwarded immediately at this stage and are re-enqueued “back to the wire” with very low latency. Packets that require additional processing can be forwarded to a slow-path module for deeper processing.

Slow-path processing may be performed independently of, or in parallel with, the fast-path processing, such that slow-path processing does not block or impede fast-path processing. Generally, a slow-path module may send and receive messages to and from a fast-path module. Slow-path module parses the transport, application and container layers of user plane packets, and executes policy based on subscriber, device, location or media session analysis and processing, for example, as determined by the slow-path processing. User plane processor 432 may forward general data traffic information and specifically media session information, e.g. bit rates, TCP throughput, RTT, etc., to other elements, including the NRM 444.

In some cases, some status characteristics may be inserted “in band” in user plane data, e.g. via HTTP enrichment. In these cases, user plane processor 432 can be configured to receive and parse control plane messages inserted by nodes in the radio access network.

Control plane processor 450 may be further configured to process the control plane messages to extract subscriber identity or mobile device identity information, and to map the mobile devices (e.g., physical or geographic location). Control plane processor 450 may forward the identity and location information to other elements, including NEC 340 or network resource model module 444.

For example, in mobile networks using 3GPP GRPS/UMTS, LTE, or similar standards, subscriber and mobile device identity information, location, as well as other mobility parameters may be gathered for subscriber, device, and location-based traffic management and reporting purposes. This can be accomplished in part by inspecting control plane messages exchanged between gateways, for example GTP-C (GPRS Tunneling Protocol Control) over the Gn interface, GTPv2 over the S4/S11 or S5/S8 interfaces, and the like, or by receiving mobility information from other network nodes, such as the RNC, Mobile Management Entity (MME) and the like.

In some cases, some status characteristics may be inserted “in band” in control plane data, e.g. via GTP enrichment. In these cases, control plane processor 450 can be configured to receive and parse control plane messages inserted by nodes in the radio access network.

In some embodiments, media service gateway 400 may also include a network event collector 340. In other embodiments, network event collector 340 may be a standalone device or server, which communicates with media service gateway 400 using a suitable network for example.

The network event collector (NEC) 340 is generally configured to aggregate multiple data inputs from network probes and nodes, and to process and transform the event data into a status characteristic indication message for transmission to the network resource model module 444.

In some cases, NEC 340 may operate in a continuous mode, in which NEC 340 continuously evaluates network nodes to determine whether the load is within the target zone for monitoring (e.g 30%-100%). If the load is below this monitored zone then the NEC does not transmit further updates to NRM module 444. If the utilization load is determined to be within the target range then fine grained monitoring is instigated and the NEC 340 periodically transmits new utilization load values to the NRM module 444. The NEC 340 will then actively monitor the affected RAN, backhaul or core node on a periodic basis and report the utilization load to the NRM module 444 until the utilization load exits the monitored target zone. Optionally, the NEC 340 may notify the NRM module 444 when the utilization load exits the monitored target zone, or may notify the NRM module 444 at reduced intervals when the utilization load is outside the monitored target zone.

In some cases, NEC 340 may operate in a simplified threshold mode, in which the NEC 340 monitors network nodes to determine whether utilization load has crossed pre-configured thresholds. In the simplified threshold mode, NEC 340 transmits status updates to NRM module 444 when a pre-configured threshold has been crossed. This can drastically reduce the signaling required between the NEC 340 and the NRM module 444, thus increasing system scalability.

A media session may generally be considered to have been identified once sufficient traffic relating to that media session has been observed at the application layer. In most cases, the application layer protocols used for media streaming can generally be identified by analyzing the first few bytes of payload data. After identifying the application payload, the payload can be parsed to find the media content, if any. This can be performed by dividing the communication into independent interactions, which may correspond to individual request/response pairs. Each interaction is evaluated to determine if the content is streaming media. If the interaction contains streaming media, it is further analyzed to extract media characteristics. Those interactions sharing common media characteristics may be encapsulated into streams. A media session may comprise a collection of one or more streams.

Referring now to FIG. 5, there is illustrated a simplified schematic block diagram of an example traffic management system 500.

System 500 generally includes a control plane processor 550, a user plane processor 530, a network event collector 540, a network resource model module 544 and a media service gateway 520.

Control plane processor 550 may be an implementation of control plane processor 450 of FIG. 4. Control plane processor 550 receives and processes control plane data to extract identity and location information, as described with reference to control plane processor 450. Upon processing the control plane data, control plane processor 450 transmits the identity and location information to network resource model module 544

User plane processor 530 may be an implementation of a packet processing element, such as packet processing element 430 of FIG. 4. User plane processor 530 receives and processes user plane traffic to identify media flows or sessions as described with reference to packet processing element 430, and forwards media session information to network resource model module 544.

Network event collector 540 may be an implementation of network event collector 340, as described herein. Network event collector 540 generally receives information from network probes or node feeds, processes the information and transmits updates or utilization load levels, or both, to network resource model module 544. Network event collector 540 may receive this information via any number of protocols, e.g., proprietary binary, or standard SOAP or Diameter protocols.

Network resource model module 544 may be an implementation of network resource model module 344 or 444, as described herein.

In at least some embodiments, NRM module 544 configured to maintain a Network Resource Model (NRM). The NRM can be considered as a simplified multi-tier map of the resources within a monitored network. Each location, backhaul network and core network is modeled as a “node” with corresponding network connections also modeled as links. The utilization load for each node can be modeled as a continuously varying utilization load level. In some cases, to reduce signaling required within the system, an active monitored zone of operation can be specified (e.g., 30%-100%) as it may not be necessary to model resources in very lightly loaded locations.

Generally, utilization load information is delivered from network probes and/or network elements from the locations, backhaul networks and core networks, for example via event notifications to the NEC 540. Alternatively, this information may be inserted directly into user or control plane data, i.e. delivered in-band, e.g. via HTTP enrichment, by those same network probes and/or network elements from the RANs, backhaul networks and core networks. The NRM is thus a virtualized resource model of the network for the monitored domains.

NRM module 544 can be further configured to correlate location-ids (e.g., cell-id of a location, service area identification, backhaul network identification, etc.) to the associated network nodes or resources, to maintain a simplified status for resources.

For out-of-band delivery, utilization load levels can be imported via a Network Event Collector function that filters, models and adapts network data to generate discrete, event-based messages based on modeled utilization load levels, which can be sent to the NRM module.

Backhaul level resources provide a backhaul id and indicate which cell level resources each backhaul id serves. Core level resources are associated with respective backhaul resources to determine which domain they are connected through. This allows the NRM module to determine the connectivity and topology of the inter-connected network.

Protocols like Link Layer Discovery Protocol (LLDP) can be used to assist in connectivity modeling. In some cases, the topology can be manually configured, but the manual approach is generally a slow and error prone way of obtaining the topology information.

In some cases, the NRM module may also obtain information directly from the control plane and user plane functions of an associated gateway, including a media service gateway 400, GGSN, P-GW, etc.

Control plane data provides the subscriber identity and device location to the NRM module for domains that are actively being monitored and managed.

User plane traffic monitoring allows for the determination of packet loss statistics, TCP flow status, HTTP-enriched headers of utilization load for each media session, and other information obtainable from the user data.

In some cases, the NRM module 544 can correlate control plane information, e.g. a GTP location update, and user plane information, e.g. inferences regarding utilization based on information from the TCP layer, to identify one or more specific RAN nodes being used by a mobile device for a media session or flow. Data received from multiple sources may refine and enhance existing data within the model. In addition, data may become stale over time and a new explicit event received from the control plane (e.g., update a session due to location move) may provide newer, more accurate data. The model can then be updated to reflect this new data. This explicit event based message may be received ahead of periodic or load threshold based reporting.

Accordingly, the NRM module 544 can combine control plane data, user plane traffic and network event data to determine a status for each node within the network.

In some cases, the NRM can be simplified into a small number of discrete threshold levels of utilization (e.g., three). These can be labeled as “green, yellow, red” or “white, shaded, black”, etc. These labels can be based on configurable or pre-configured thresholds. For example, where U is the utilization:

U<50%=WHITE

50%<U<75%=SHADED

U>75%=BLACK

The NRM allows for a subscriber or mobile device to have one or many sessions, in the same location.

Media service gateway 520 can be configured to transcode media sessions, based on inputs from NRM module 544 and other components of a media service gateway (e.g., policy engine). Accordingly, the media service gateway generally performs video traffic management and service delivery. It may be deployed in wireless and wired packet networks for the purpose of managing the media sessions in the network, and thus may implement a real-time QoE model that measures the perceived experience of every media session as described herein. The media service gateway 520 can abstract the complexities of multiple video technologies and streaming protocols to deliver a uniform service delivery platform based on QoE. The QoE data can be combined with network topology, location and utilization load information and used to drive the video policy engine that mediates the available resources and sessions in order to make optimal use of the network while delivering the best possible subscriber experience.

Accordingly, system 500 can be deployed in or at the edge of a core network, and can model the utilization load of one or more core, backhaul or RAN networks to make traffic management and policy decisions related to the video traffic traversing the network, in order to avoid entering congestion conditions in any of the monitored nodes. Progressively more aggressive traffic management techniques for video traffic can be used in response to increased utilization load and fluctuating throughput characteristics. By avoiding entering the congestion condition (congestion avoidance) the resource utilization of the network can be maintained with a more consistent response to traffic load with an improved video experience for consumers.

It will be appreciated that the functional modules of system 500 may be provided in a single network device or may be distributed across multiple devices. For example, all functions may be implemented in a media service gateway 400. In another example, the network event collector 540 is implemented outside the media service gateway 520. In yet another example, the network event collector 540 and network resource model module 444 may be implemented in a PCRF server.

Referring now to FIGS. 6A and 6B, there are illustrated example diagrams of a network resource model, such as the network resource model that may be used by an NRM module, such as NRM module 544.

FIG. 6A shows one example state of an example network resource model which may be used for network 100 of FIG. 1. Each model has a plurality of nodes that generally correspond to each of the core networks, backhaul networks and RANs of network 100.

For example, network resource model 6000A has two core nodes 6050 and 6051, which correspond to core networks 150. Core nodes 6050 and 6051 are connected, to indicate that the corresponding core networks 150 are also linked in network 100.

Similarly, network resource model 6000A has backhaul nodes 6040 and 6041 connected to core node 6050, representing the corresponding backhaul networks 140 of network 100. A further backhaul node 6042 is connected to core node 6051, representing the corresponding element of network 100.

Again similarly, network resource model 6000A has cell site or location nodes 6020, 6021, 6022 and 6023 connected to backhaul nodes 6040, 6041 or 6042, according to the respective link in network 100. Each location node may be modeled based on active device sessions at the corresponding cell site or location.

Table 1 illustrates example utilization load levels for a portion of NRM 6000A.

TABLE 1

| Location-Ids | | | | | | |
|---|---|---|---|---|---|---|
| | Cell | | | | | |
| Cell | Uti- | Backhaul | Backhaul | Core | Core | |
| ID | lization | ID | Utilization | ID | Utiliation | Subscriber |
| 6020 | 53% | 6040 | 23% | 6050 | 6% | Subscriber#1 |
| | | | | | | Subscriber#2 |
| | | | | | | Subscriber#3 |
| 6021 | 76% | 6040 | 23% | 6050 | 6% | Subscriber#4 |
| | | | | | | Subscriber#5 |
| 6022 | 43% | 6041 | 10% | 6050 | 6% | Subscriber#6 |
| 6023 | 11% | 6042 | 5% | 6051 | 1% | Subscriber#7 |

Referring now to FIG. 6B, there is illustrated a simplified NRM 6000B, in which each of the nodes corresponds to the nodes of NRM 6000A. However, in NRM 6000B, specific utilization load levels have been replaced by threshold based states. For example, nodes with utilization load levels below 30% are unshaded, nodes with utilization load levels between 30% and 75% are shaded with diagonal lines, and nodes with utilization load levels greater than 75% are shaded in black. It will be appreciated that various numbers of thresholds and threshold levels may be chosen.

For example, node 6020 is shaded in NRM 6000B to indicate that a first utilization threshold has been met. The first utilization threshold may be a first predetermined load or utilization load level. For example, the first predetermined level may be a percentage of available bandwidth utilization (e.g., 30%) for the cell site or location corresponding to node 6020, as determined by NRM module 444. In another example, the first predetermined level may be a percentage of available load (e.g., 60%), as determined by the cell site or location corresponding to node 6020, for example based on radio transmit/receive power levels. Other metrics may also be used, either individually or in combination, to determine the utilization load level.

Node 6021 is differently shaded to indicate that a second utilization threshold has been met. As with the first utilization threshold, the second utilization threshold may be a second predetermined load or utilization load level. For example, the second predetermined level may be a higher percentage of available bandwidth utilization (e.g., 75%) for the RAN probe corresponding to node 6021.

Depending on the specific nodes that indicate increasing utilization load levels, different actions may be taken by media service gateway 205. For example, in the scenario illustrated by FIG. 6A or 6B, all media sessions for client devices connected to the cell sites or locations represented by nodes 6020 and 6021 may be subjected to a utilization load level policy in which transcoding is applied to media sessions, in an effort to reduce bit rates. In some cases, the level of bit rate reduction may be greater for node 6021 than for node 6020, since node 6021 is at a higher utilization load level.

At the same time, client devices connected to cell sites represented by node 6023 may be allowed to establish or continue media sessions in unmodified form, since these nodes are not determined to be congested or experiencing high utilization load levels.

For example, if an update from a location indicates that a utilization load level is increasing beyond a threshold (e.g., 50%), one or more strategies may be employed. The strategies may include Normalization or Tiered Services, for example. In the Normalization strategy, all media sessions may have their QoE metric decreased from, for example, 3.0 to 2.5. In the Tiered Services strategy, “gold” tier subscribers may be allowed to maintain a QoE metric of 3.0 (and allowed to continue streaming at HD resolution), whereas “silver” tier subscribers may have their QoE metric decreased to 2.5 (and limited to streaming at or below SD resolution), while “bronze” tier subscribers may have their QoE metric decreased still lower to 2.0.

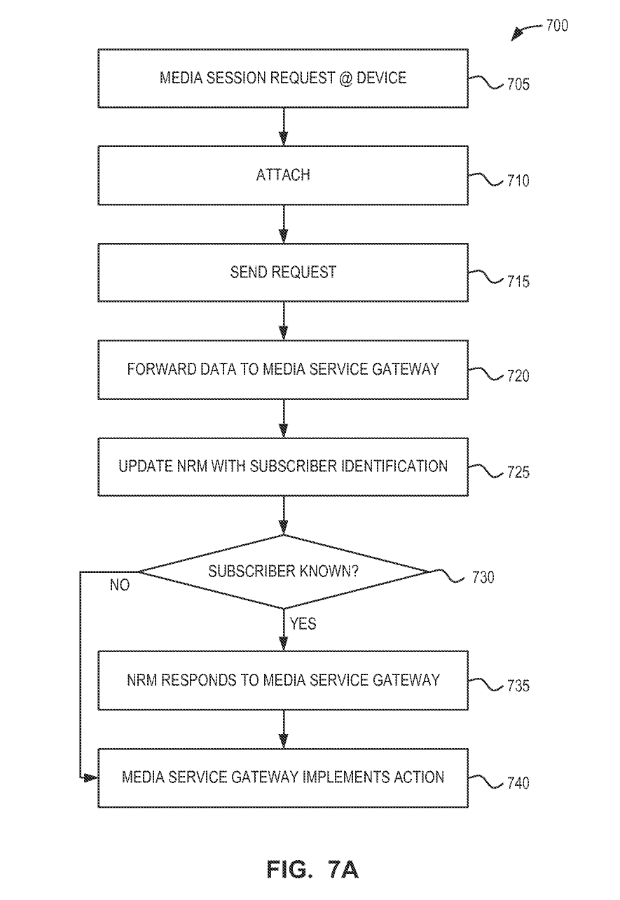

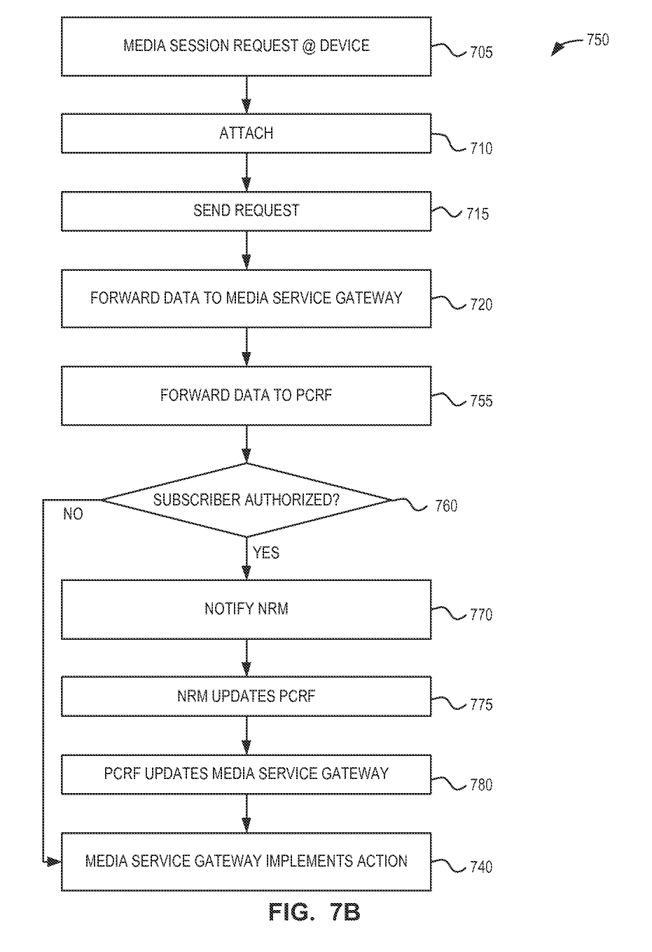

Referring now to FIG. 7A, there is illustrated a process flow diagram for a method of session tracking according to an example embodiment.

Method 700 may be implemented, for example, when a media session request is received for a node in an initially unloaded state.

At 705, a dedicated media application or browser on the client device initiates a media session request (e.g., an HTTP request, RTSP request, RTMP request, etc.), for example, by forming a request for streaming video.

In response to the application's request, the client device attaches to the network at 710 via one or more cell sites on a RAN and activates a session, which in some cases may cause a new mobile station (MS) packet data protocol (PDP) context to be activated, or an IP Connectivity Access Network (IP-CAN) session to be started if one does not already exist.

At 715, the media session request is transmitted to the data network using the session. A network element forwards the user data including the media session request to a media service gateway at 720. Depending on the network type and configuration, the network element may be a Node B, RNC, SGSN, GGSN, or the like.

At 725, the media service gateway updates its NRM, for example by providing a session update to a NRM module. The information may include the IMSI, MSISDN, or IP address of the client device, or a combination thereof. The session update may further include estimated media bandwidth rate requirements for the media session, as determined by the media service gateway based on inspection of the media session request, an initial response to the media session request from a media server, or both.

At 730, the NRM module may determine whether the media session is to be monitored. For example, if the media session is not using a RAN node that is within an active management threshold, then the NRM module may determine that the media session need not be tracked. Optionally, the NRM module may store a record of the media session, but take no immediate action regarding utilization management.

If the NRM module determines that no immediate utilization management action is required, it may notify the media service gateway accordingly.

Otherwise, if the NRM module determines that the media session is using a RAN node or other network node that is experiencing high utilization load levels (i.e., is within an active management threshold), the NRM module may transmit a message at 735 to the media service gateway indicating a current location of the client device (e.g., which nodes it is using), the status of the nodes (e.g., either a percentage utilization, or a threshold level). Optionally, the NRM module may include an indication of other client devices currently active on the nodes.

In either case, the media service gateway may determine an action to take regarding the client device media session at 740. The determined action may be based on an intelligent policy engine, and may include blocking, video buffer shaping, transcoding, policing, and the like, based on current node utilization load level and media stream parameters. In some cases, the media service gateway may determine to adjust media sessions for other client devices utilizing the same node or nodes, for example, to create capacity to allow a modified media session access to the resources in the target node.

Referring now to FIG. 7B, there is illustrated a process flow diagram for a method of session tracking according to another example embodiment.

Acts 705, 710, 715, 720 and 740 of method 750 are generally analogous to those of method 700. Method 750 may be performed where a PCRF server (e.g., part of the 3GPP PCC architecture) is deployed, to perform service authorization against a subscribed service profile.

Accordingly, at 755, the media service gateway may send subscriber data, such as IMSI, MSISDN, IP address and media bandwidth rate requirements to the PCRF server.

At 760, the PCRF server can evaluate a service policy for the subscriber (and/or client/device) using a subscriber profile database. The PCRF can thereby authorize or deny the media session.

If the media session is authorized, the PCRF server may transmit the subscriber data to the NRM module at 770, including media bandwidth rate requirements as detected.

The NRM module may transmit a message at 775 to the PCRF server indicating a current location of the client device (e.g., which nodes it is using), the status of the nodes (e.g., either a percentage utilization, or a threshold level). Optionally, the NRM module may include an indication of other client devices currently active on the nodes.

At 780, the PCRF server transmits its response to the media service gateway. If the media session is not authorized, the PCRF server may respond to the media service gateway accordingly, in which case the media service gateway can take action to re-direct or block the media session. Otherwise, if the media session is authorized, the PCRF server response contains the authorization, and may further include information received from the NRM module usable to manipulate the media session.

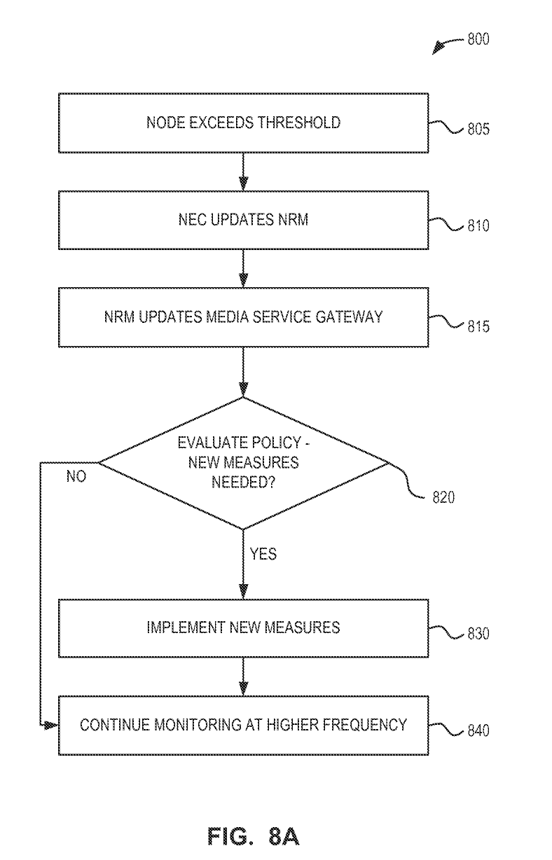

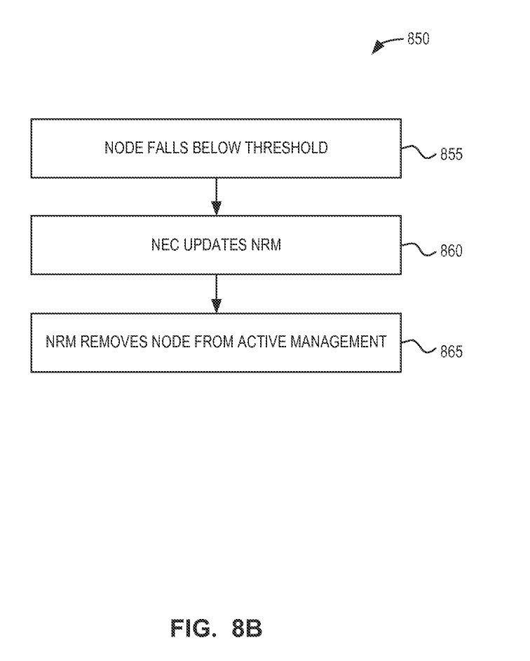

Referring now to FIG. 8A, there is illustrated a process flow diagram for an example NRM update process used when a utilization load level is increased for a node.

Method 800 begins at 805, for example when a network event controller receives data indicating that a utilization load level for a network node has entered an active management zone by crossing a predetermined threshold (e.g., more than 30% utilization). This may occur, for example, when a new user session is created, or when a client device enters a region serviced by the network node (e.g., soft or hard handover).

In general, the network node may have only limited information from which to make determinations of utilization load level at the node. Accordingly, the network resource model module may receive only a coarse estimate of utilization load level from the control plane and user plane data. More detailed utilization load levels can be computed by an NRM module based on the additional information provided by the NEC, via radio transmit/receive power levels, number of active sessions or devices, and the like communicated to the NEC from network probes or node feeds.

At 810, the NEC transmits an indication to an NRM module with the new utilization load level for the node, and optionally with a list of the currently active devices at the affected node. For example, the indication may include various data relating to the client device and session in addition to the utilization load level, such as the IMSI of each client device, the cell identification (cell-ID), cell load information element (IE), Radio Access Technology (RAT) type IE and geographical/location IE. In some cases, the NEC may provide a cell-ID of a previous cell site or RAN servicing the client device, in the case of a handover.

At 815, the NRM module transmits a utilization load level indication to the media service gateway, which may include a list of the currently active subscribers and sessions at the affected node. The utilization load level indication transmitted to the media service gateway may be based on data received from the NEC, and information extracted from control and user plane data, as described with reference to FIG. 5.

At 820, the media service gateway may re-evaluate policy rules, and determine whether further media traffic management is required, for example whether the currently active devices have media sessions that should be altered.

If further media traffic management is required, media service gateway may implement the new management measures at 830.

In either case, the NEC can continue to monitor the utilization load level at the affected node at 840, either by pulling status updates on a more frequent basis, or by instructing probes, control or user plane functions to provide more frequent updates.

Referring now to FIG. 8B, there is illustrated a process flow diagram for an example NRM update process used when a utilization load level is decreased for a node.

Method 850 begins at 855, for example when a network event controller receives data indicating that a utilization load level for a network node exited an active management zone by crossing a predetermined threshold (e.g., less than 30% utilization). This may occur, for example, when an existing user session is ended, or when a client device leaves a region serviced by the network node (e.g., soft or hard handover).

At 860, the NEC updates an NRM module with the new utilization load level for the node, and optionally with a list of the currently active devices at the affected node, if any. In some cases, the NEC may provide a cell-ID of a new cell site or RAN servicing the client device, in the case of a handover.

At 865, the NRM module may remove the node from the NRM, indicating that the node is no longer under active management.

Optionally, the NEC can continue to monitor the utilization load level at the affected node at a reduced rate, either by pulling status updates on a less frequent basis, or by instructing probes or nodes to provide less frequent updates.

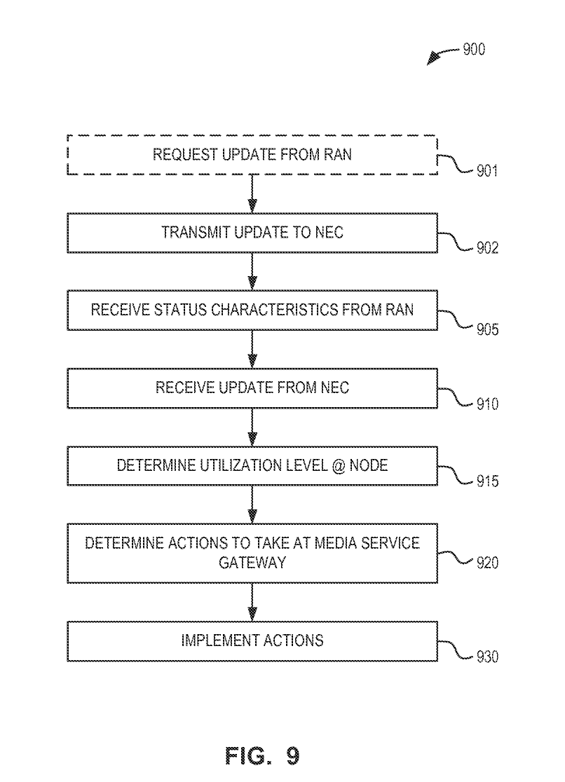

Referring now to FIG. 9, there is illustrated a process flow diagram for an example monitoring process, such as the process carried out by an NRM module 544 in conjunction with a network event collector 540 and a media service gateway 520.

Optionally, process 900 may begin at 901, with NRM module 544 requesting a status characteristic from a NEC.

Otherwise, process 900 may begin at 902 with a network probe or node feed (e.g., RNC feed) transmitting at least one status characteristic associated with one or more cell sites or locations in the RAN to the NEC, in response to a determination made by a probe or node about the cell site or location (for example, a utilization load level exceeding a first predetermined threshold, e.g., 50%, of available capacity at the cell site). The status characteristic may include the utilization load level, a radio transmit/receive power level, a signal-to-noise ratio, or a bit rate. In some cases, the status characteristic may also include a cell-ID of the cell site and a list of IMSI numbers corresponding to client devices connected to the client node monitored by the cell probe.

Generally, status characteristics are items of information that may be received by the NEC from network probes or node feeds in the RAN.

In some cases, the RAN may be augmented to insert some of this information “in-band” in the user plane traffic (e.g. using HTTP enrichment) or control plane traffic (e.g. using GTP enrichment) in which case the control plane processors or user plane processors of a media service gateway can extract this information and provide it to the NRM module.

More commonly, status characteristics can be provided out-of-band by the network probes or node feeds to the NEC, which then aggregates and adapts the information for consumption by the NRM module.

At 910, the NEC may transmit an indication of the at least one status characteristic to NRM module 544. The indication may include individual characteristics in unmodified form, or may comprise aggregate characteristics, or both. NRM module 544 receives the indication at 915.

Based on the at least one status characteristic in the indication, and optionally based on other information monitored by media service gateway 520, NRM module 544 may determine a network utilization load level for one or more locations within the RAN at 915.

Based on the network utilization load level, media service gateway 520 may determine whether to take action on one or more data flows at 920. The determination may be based on one or more global or local policies, as described herein. For example, in some cases, an action may be applied only to media sessions, whereas in other cases, an action may be applied to all data flows.

If an action is required in accordance with one or more policy, media service gateway 520 may implement the policy at 930. For example, the action may include transcoding the media session, video buffer shaping of the media session, marking the media session, and blocking the media session, as described herein. Other policies may also be applied, such as subscriber-based policies, as described herein.

In general, the media service gateway increasingly constrains the bit rate of video streaming sessions by transcoding during periods of high bandwidth usage in heavily utilized network nodes.

Once utilization at the affected nodes decreases, the media service gateway may optionally restore the original bit rate, if desired.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. The scope of the claims should not be limited by the preferred embodiments and examples, but should be given the broadest interpretation consistent with the description as a whole.

We claim:

1. A system for managing traffic on a network, the network comprising a plurality of nodes facilitating a media session between a server and a client device, the system comprising:
a network resource modeling module configured to receive an indication of the at least one status characteristic; determine a network utilization load level based on the at least one status characteristic; and
at least one processor configured to perform a media session action based on the network utilization load level.

2. The system of claim 1, further comprising a network event collector configured to receive at least one status characteristic from at least one selected node of the plurality of nodes, wherein the network resource modeling module receives the indication of the at least one status characteristic from the network event collector.

3. The system of claim 2, wherein the network event collector is further configured to determine at least one additional status characteristic at one or more other nodes in the plurality of nodes.

4. The system of claim 2, wherein the at least one status characteristic is transmitted to the network event collector in response to a change in a utilization load level determined by the at least one selected node.

5. The system of claim 2, wherein the at least one status characteristic is transmitted to the network event collector in response to a request from the network event collector.

6. The system of claim 2, wherein the at least one selected node is within a radio access network.

7. The system of claim 2, wherein the at least one selected node monitors at least a portion of a radio access network.

8. The system of claim 2, wherein the at least one status characteristic is the utilization load level determined by the at least one selected node.

9. The system of claim 2, wherein the utilization load level is determined based on radio transmit/receive power levels at the at least one selected node.

10. The system of claim 2, wherein the network resource modeling module is further configured to model a client device media session associated with a subscriber at the at least one selected node.

11. The system of claim 1, wherein the media session action is based on the network utilization load level.

12. The system of claim 1, wherein the media session action is selected from the group consisting of: transcoding the media session, video buffer shaping the media session; policing the media session; marking the media session; and blocking the media session.

13. The system of claim 1, wherein the at least one status characteristic is selected from the group consisting of a radio receive power level, a radio transmit power level, a signal-to-noise ratio and a bit rate.

14. The system of claim 1, wherein the at least one status characteristic corresponds to a plurality of client devices.

15. The system of claim 1, wherein the media session is modeled based on a location and an identity of the client device on the network.

16. The system of claim 15, wherein the at least one status characteristic is transmitted to the network event collector in response to a change in the location of the client device.

17. A method for managing traffic on a network, the network comprising a plurality of nodes facilitating a media session between a server and a client device, the method comprising:
receiving, at a network resource modeling module, an indication of the at least one status characteristic;
determining a network utilization load level based on the at least one status characteristic; and
performing a media session action based on the network utilization load level.

18. A non-transitory computer-readable medium storing computer-executable instructions, the instructions for performing a method for managing traffic on a network, the network comprising a plurality of nodes facilitating a media session between a server and a client device, the method comprising:
receiving, at a network resource modeling module, an indication of the at least one status characteristic;
determining a network utilization load level based on the at least one status characteristic; and
performing a media session action based on the network utilization load level.
